(19) United States
(12) Patent Application Publication
(10) Pub. No.: US 2024/0332845 A1
(43) Pub. Date: Oct. 3, 2024

(54) SAFETY SHIELD ASSEMBLY FOR POWER RECEPTACLE AND RELATED POWER RECEPTACLE

(71) Applicant: Chengli LI, Suzhou (CN)

(72) Inventors: Chengli LI, Suzhou (CN); Xiaoming ZHANG, Suzhou (CN); Zenghui LV, Suzhou (CN)

(73) Assignee: Chengli LI, Suzhou (CN)

(21) Appl. No.: 18/297,488

(22) Filed: Apr. 7, 2023

(30) Foreign Application Priority Data
Mar. 28, 2023 (CN) 202320638350.5

(51) Int. Cl. H01R 13/453

(52) U.S. Cl. CPC H01R 13/4534

(57) ABSTRACT

A safety shield assembly for a power receptacle includes a slider frame and first and second slider blocks disposed therein. The slider frame has a bottom panel and a perpendicular sidewall along a periphery thereof. The bottom panel defines first and second openings having shapes corresponding to shapes of socket holes of the power receptacle. The first and second slider blocks respectively have first and second blocking portions respectively corresponding in position to the first and second opening. The bottom panel of the slider frame further includes guiding members, where the first and second slider blocks move within a space defined by the sidewall, as guided by the guiding members and under spring force of resilient members, between first positions where the first and second openings are covered, and second positions where the first and second openings are exposed. The safety shield assembly is reliable, safe, and convenient to use.

### BACKGROUND OF THE INVENTION

This invention generally relates to home appliances, and in particular, it relates to a safety shield assembly for a power receptacle and a power receptacle having such a safety shield assembly.

Power receptacles are widely used in homes and public places. In most receptacles, the socket holes are exposed. If a metal piece or other conductive object is inserted into the socket holes, such as by a child or even by an adult due to inadvertent operation, electrical shocks may result, causing personal harm or property damage. Some existing power receptables have safety shields or shutters, but they often have complex structures and are difficult to assemble. Thus, they are often unsuitable for automated production and assembly, resulting in high cost and low production efficiency. Therefore, there is a need for improved power receptacles with safety shields with simplified structures and reduced manufacturing cost.

### SUMMARY OF THE INVENTION

Accordingly, the present invention is directed to a safety shield assembly for power receptacle that substantially obviates one or more of the problems due to limitations and disadvantages of the related art. The safety shield assembly can move when objects are inserted into the socket holes, and can effectively prevent objects other than power prongs to be erroneously inserted, thereby improving safety and prevents electrical shock. The safety shield assembly is low cost and easy to assemble.

In a first aspect, the present invention provides a safety shield assembly for a power receptacle, the safety shield assembly including: a slider frame, having a bottom panel and a sidewall that extends along a periphery of and perpendicularly from the bottom panel, the bottom panel defining a first opening and a second opening having shapes corresponding to shapes of socket holes of the power receptacle; a first slider block, disposed in the slider frame, including a first blocking portion corresponding in position to the first opening; and a second slider block, disposed in the slider frame, and including a second blocking portion corresponding in position to the second opening; wherein the bottom panel further includes one or more guiding members, wherein the first slider block and second slider block are configured to move within a space defined by the sidewall, as guided by the guiding members and under spring force of one or more resilient members, between first positions where the first opening and the second opening are covered, and second positions where the first opening and the second opening are exposed.

Based on the above technical characteristics, the present invention may include any one or more of the embodiments below.

In some embodiments, the first slider block includes a first support arm, wherein the first blocking portion extends perpendicularly from the first support arm, wherein the first slider block further includes a first drive portion which extends perpendicularly from the first support arm and is parallel to and spaced apart from the first blocking portion; wherein the second slider block includes a second support arm, wherein the second blocking portion extends perpendicularly from the second support arm, wherein the second slider block further includes a second drive portion which extends perpendicularly from the second support arm and is parallel to and spaced apart from the second blocking portion; wherein the first slider block and second slider block are disposed in a nested arrangement, where the first blocking portion is located below the second drive portion, and the second blocking portion is located below the first drive portion, wherein the first slider block and second slider block are configured to move in a same direction to the second positions when the first drive portion and the second drive portion are simultaneously driven.

In some embodiments, the one or more guiding members includes a first guiding member corresponding to the first slider block and a second guiding member corresponding to the second slider block, wherein the first support arm has a first sliding portion that cooperates with the first guiding member, and the second support arm has a second sliding portion that cooperates with the second guiding member.

In some embodiments, the first guiding member and the second guiding member are disposed in parallel, each being a guiding groove or a guiding rail, and wherein each of the first sliding portion and second sliding portion is a sliding block, a sliding rail, or a sliding groove.

In some embodiments, the first drive portion includes a first inclined surface and the second drive portion includes a second inclined surface, wherein the first slider block or the second slider block are configured to move individually when an inserted object pushes against the first inclined surface or the second inclined surface, and wherein the first slider block and the second slider block are configured to move simultaneously in a same direction when two inserted objects simultaneously push against the first inclined surface and second inclined surface.

In some embodiments, the second opening includes a first portion and a second portion perpendicular to each other, wherein the second blocking portion of the second slider block corresponds to the first portion of the second opening; wherein the safety shield assembly further includes: a third slider block disposed in the slider frame, including a third blocking portion corresponding to the second portion of the second opening; wherein the one or more guiding members further includes a third guiding member, and the third slider block includes a third sliding portion cooperating with the third guiding member, wherein the third slider block is configured to move between a first position where it covers the second portion of the second opening and a second position where it exposes the second portion of the second opening.

In some embodiments, the third guiding member is perpendicular to the first guiding member or the second guiding member, and is a guiding groove or a guiding rail, and the third sliding portion is a sliding block, a sliding rail, or a sliding groove.

In some embodiments, the slider frame further includes a blocking arm extending perpendicularly from the sidewall, wherein the blocking arm is adjacent to and extends approximately parallel to the second portion of the second opening, and defines a movement space of the third slider block, and wherein an inner surface of a portion of the sidewall parallel to the blocking arm has an avoidance slot.

In some embodiments, when the second slider block is in its first position, the second support arm blocks the third slider block and prevents the third slider block from moving to its second position.

In some embodiments, the second support arm includes a cam block at its end, wherein the cam block has an inclined lead-in surface and is configured to be inserted into a corresponding drive groove of the third slider block, wherein the drive groove has a guide surface that corresponds to the lead-in surface of the cam block, and wherein the cam block transmits the spring force of the resilient members to the third slider block via a movement along the drive groove.

In some embodiments, the second support arm has an avoidance slot adjacent the cam block, which is configured to allow the third slider block to move to the second position.

In some embodiments, the slider frame further includes an indicator opening configured to accommodate an indicator device to pass through, wherein the indicator opening is located near the sidewall.

In some embodiments, the slider frame further includes a support block that protrudes from the bottom panel, and wherein the resilient members include a first resilient member compressed between the support block and the first drive portion and a second resilient member compressed between the sidewall and the second drive portion.

In another aspect, the present invention provides a power receptacle, which includes: a shell including a top cover with socket holes; blade-receiving conductor plates disposed within the shell and spatially correspond to the socket holes; and the safety shield assembly according to any of the above embodiments, disposed between the top cover and the conductor plates.

The safety shield assembly according to embodiments of the present invention is safe and reliable, easy to use, and applicable to a variety of power receptacles. Further, because the safety shield assembly has a simple structure and is easy to assemble, it is suitable for mass production and assembly with high efficiency, has good cost-effectiveness, and is widely applicable.

### BRIEF DESCRIPTION OF DRAWINGS

Preferred embodiments of the present invention are described with reference to the drawings. In these drawings, like reference symbols represent like features.

FIG. 1 illustrates a power receptacle, showing the shape and arrangement of socket holes.

FIG. 2 is an exploded view illustrating a power receptacle of FIG. 1 employing safety shield assemblies according to embodiments of the present invention.

FIG. 3A illustrates a safety shield of the embodiment of FIG. 2 according to an embodiment of the present invention.

FIG. 3B is an exploded view of the safety shield of FIG. 3A.

FIG. 4A illustrates a slider frame of the safety shield of FIG. 3B.

FIG. 4B illustrates an alternative slider frame of the safety shield according to another embodiment of the present invention.

FIG. 5A illustrates a first slider block of the safety shield of FIG. 3B.

FIG. 5B is a bottom view of the first slider block of FIG. 5A.

FIG. 6A illustrates a second slider block of the safety shield of FIG. 3B.

FIG. 6B is a bottom view of the second slider block of FIG. 6A.

FIG. 7 illustrates a third slider block of the safety shield of FIG. 3B from different angles.

FIGS. 8A and 8B are cross-sectional views of a power receptacle with the safety shield assembly according to an embodiment of the present invention, showing two states where the safety shield is respectively in a first and a second position.

FIG. 9A is a cross-sectional view of the power receptacle with the safety shield assembly according to embodiments of the present invention, showing its state when an object is inserted in the first socket hole.

FIG. 9B is a cross-sectional view of the power receptacle with the safety shield assembly according to embodiments of the present invention, showing its state when an object is inserted in the second socket hole.

FIG. 10A is a cross-sectional view of the power receptacle with the safety shield assembly according to embodiments of the present invention, showing its state when two plug prongs are simultaneously inserted in two socket holes.

FIG. 10B is a cross-sectional view of the power receptacle with the safety shield assembly according to embodiments of the present invention, showing its state when two plug prongs of other shapes are simultaneously inserted in two socket holes.

### DETAILED DESCRIPTION OF THE INVENTION

Preferred embodiments of the present and their applications are described below. It should be understood that these descriptions describe embodiments of the present invention but do not limit the scope of the invention. When describing the various components, directional terms such as “up,” “down,” “top,” “bottom” etc. are not absolute but are relative. These terms may correspond to the views in the various illustrations, and can change when the views or the relative positions of the components change.

In the descriptions below, terms such as “comprising”, “including”, “containing”, “having”, etc. are intended to be open-ended and do not exclude elements, step or components not specifically listed. The term “consisting of” excludes elements, step or components not specifically listed. The term “consisting essentially of”' means including the specifically listed elements, step or components and other elements, step or components that do not materially affect the basic and novel characteristics of the claimed invention. The term “comprising” covers “consisting of” and “consisting essentially of”.

In this disclosure, unless specifically indicated, terms such as “first”, “second”, etc. do not connote a temporal or spatial sequence or a particular number of parts.

In this disclosure, unless otherwise indicated, terms such as “mount”, “connect”, “couple”, “link” etc. should be understood broadly; for example, they may be fixed connections, or removable or detachable connections, or integrally connected for integrally formed; they may be directly connected, or indirectly connected via intermediate parts, and may refer to internal connection of two components or mutual interactions of two components. Those skilled in the relevant art can readily understand the meaning of these terms as used in this disclosure based on the specific description and context.

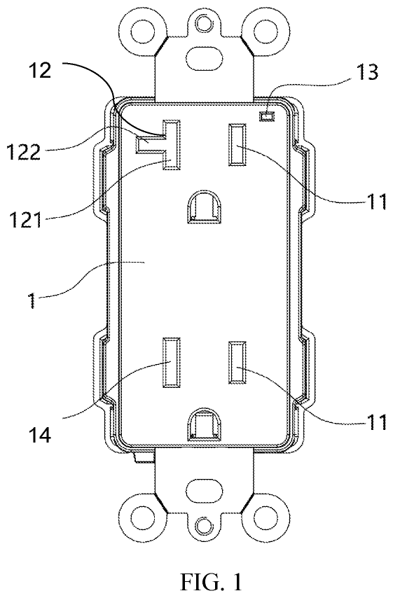

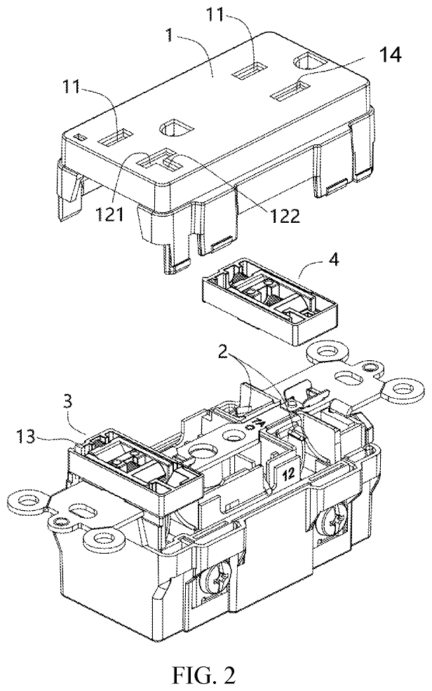

As shown in FIGS. 1 and 2, the power receptacle includes a shell or body and blade-receiving conductor plates disposed within the shell. The shell includes an upper cover 1 having multiple socket holes. In the illustrated embodiment, the upper cover 1 has two sets of socket holes corresponding to two sets of blade-receiving conductor plates 2 inside the shell; one set includes I-shaped first socket hole 11 and second socket hole 14, and another set includes an I-shaped first socket hole 11 and a T-shaped second socket hole 12. The T-shaped second socket hole 12 includes a first socket hole portion 121 and a second socket hole portion 122 perpendicular to each other. For convenience of descriptions, in this disclosure, the extension direction of the I-shaped socket holes is referred to as the longitudinal direction; the extension direction of the first socket hole portion 121 of the T-shaped socket hole is in the longitudinal direction, and the extension direction of the second socket hole portion 122 is referred to as the transverse direction which is perpendicular to the longitudinal direction. Safety shield assemblies are provided between the upper cover 1 and blade-receiving conductor plates 2. For socket holes of different shapes, a safety shield assembly 4 is suitable for the I-shaped socket holes, and a safety shield assembly 3 is suitable for both the I-shaped and the T-shaped socket holes. It should be understood that when both socket holes are I-shaped, the safety shield assembly 3 is also suitable.

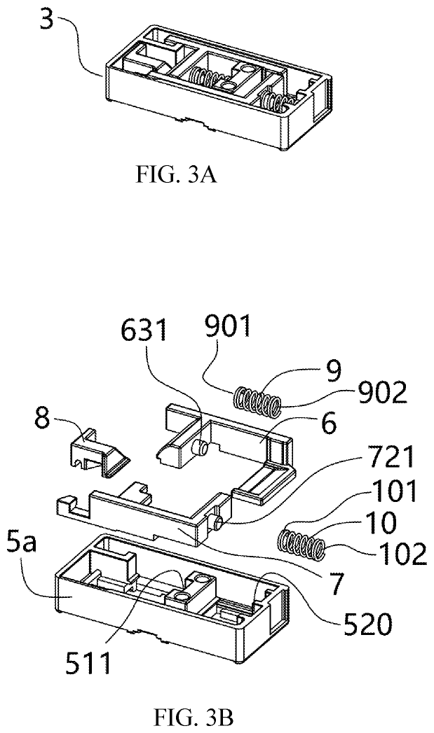

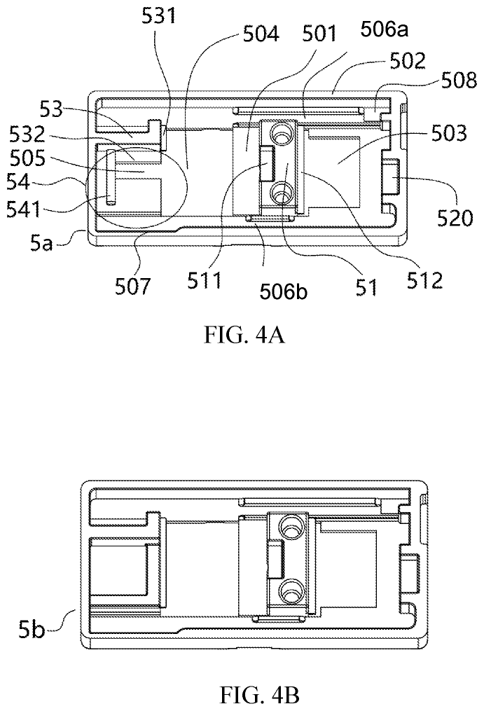

FIGS. 3A-7 illustrate a safety shield assembly 3 according to an embodiment of the present invention. The safety shield assembly 3 includes a slider frame 5a, and a first slider block 6, a second slider block 7 and a third slider block 8 disposed in the slider frame 5a. The slider frame 5a includes a bottom panel 501 and a sidewall 502 that extends along a periphery of and perpendicularly from the bottom panel 501. The sidewall 502 forms a surrounding wall that limits the movement ranges of the first slider block 6 and second slider block 7, so that these slider blocks are restrained with the slider frame 5a without falling out, while allowing them to move relative to the frame. The bottom panel 501 has multiple openings corresponding to the shapes and locations of the multiple socket holes, which may be I-shaped or T-shaped. For example, the slider frame 5a shown in FIGS. 3B and 4A has an I-shaped first opening 503 corresponding to the I-shaped first socket hole 11, and a T-shaped second opening corresponding to the T-shaped second socket hole 12. The T-shaped second opening includes a first (longitudinal) portion 504 corresponding to the longitudinal first socket hole portion 121. and a second (transverse) portion 505 corresponding to the transverse second socket hole portion 122, so that they can meet the requirements of different standard power receptacles. When the first socket hole 11 and second socket hole 14 are both I-shaped, the openings of the slider frame 5a are still suitable. When used with only I-shaped socket holes, a different slider frame 5b as shown in FIG. 4B may be used, in which case a third slider block is not needed, as will be described in more detail later.

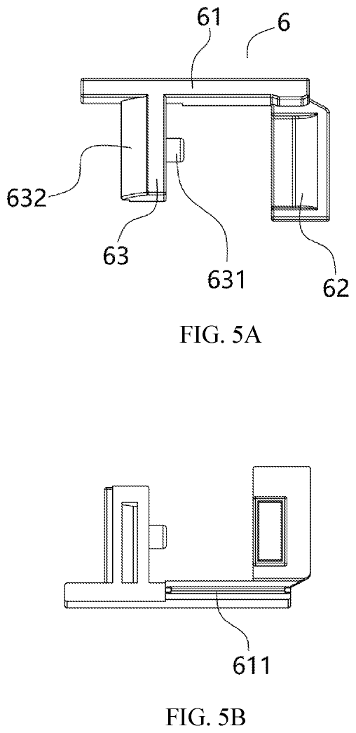

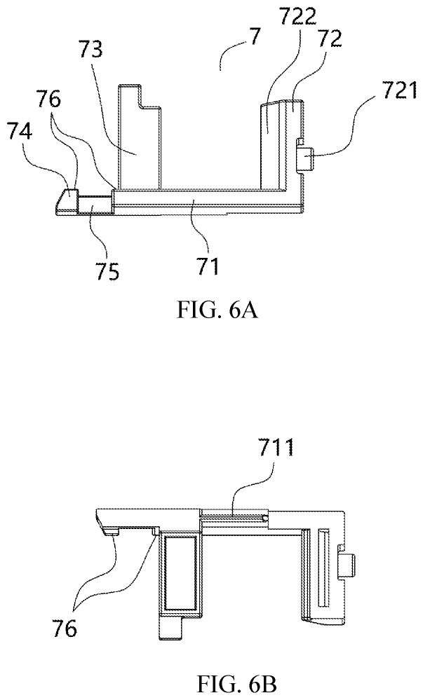

As shown in FIGS. 3B, 5A and 5B, the first slider block 6 includes a first support arm 61 and a first blocking portion 62 that corresponds in position to the first opening 503. The first blocking portion 62 extends perpendicularly from the first support arm 61, and its size and shape may be designed to suit the shape of the first opening 503. The first slider block 6 further includes a first drive portion 63, which extends perpendicularly from the first support arm 61 and is parallel to and spaced apart from the first blocking portion 62. As shown in FIGS. 3B, 6A and 6B, the second slider block 7 includes a second support arm 71 and a second blocking portion 73 that corresponds in position to the first (longitudinal) portion 504 of the second opening. The second blocking portion 73 extends perpendicularly from the second support arm 71, and its size and shape may be designed to suit the shape of the longitudinal portion of the second opening. The second slider block 7 further includes a second drive portion 72, which extends perpendicularly from the second support arm 71 and is parallel to and spaced apart from the second blocking portion 73. The bottom panel 501 of the slider frame 5a has one or more guiding members. The first slider block 6 and second slider block 7 respectively move, under the force of resilient members and as guided by the guiding members, within the space defined by the sidewall, so as to switch between first positions where they cover the first and second openings and second positions where they expose the first and second openings. When in the first positions, the safety shield assembly is in a close state, and in the second positions, the safety shield assembly is in an open state. This way, by providing the open and closed states of the safety shield assembly, the power receptacle allows a pair of plug prongs (blades) meeting the defined shape requirements to be inserted through the safety shield assembly and to come in electrical contact with the blade-receiving conductor plates 2 to receive electrical power, and can prevent prongs that do not meet the defined shape requirements, or other objects, from passing through the safety shield assembly and contacting the blade-receiving conductor plates 2, so as to prevent electrical shock.

More specifically, in the illustrated embodiment, the first slider block 6 and second slider block 7 are disposed in a nested arrangement, where the first blocking portion 62 is located below the second drive portion 72, and the second blocking portion 73 is located below the first drive portion 63. The two sliding blocks are disposed parallelly and can move relative to each other. The first slider block 6 and second slider block 7 are arranges such that when the first drive portion 63 and second drive portion 72 are simultaneously driven, they move in the same direction to the second positions. During the movement, the first slider block 6 and second slider block 7 are guided by the guiding members of the bottom panel. In some embodiments, the guiding members include a first guiding member 506a corresponding to the first slider block 6 and a second guiding member 506b corresponding to the second slider block 7. The first support arm 61 has a first sliding portion 611 that cooperates with the first guiding member 506a, and the second support arm 71 has a second sliding portion 711 that cooperates with the second guiding member 506b. As shown in FIGS. 4A, 5B and 6B, the first guiding member 506a and the second guiding member 506b are disposed in parallel, and are either guiding grooves or guiding rails, such as guide grooves as shown in the drawings. The first sliding portion 611 and second sliding portion 711 are sliding blocks, sliding rails, or sliding grooves, such as sliding rails as shown in the drawings. By providing the sidewall that defines the space for movement and providing the guiding members and the corresponding sliding portions, the slider blocks are able to stably and reliably move within the slider frame, to ensure smooth transitions between the open state and closed state. Further, by using the sliding rails and guiding grooves, the sliding contact surfaces are relatively small, making the sliding motion smoother, thus improving user experience.

The transitions of the first slider block 6 and second slider block 7 between the first positions and second positions are achieved by the driving forces of the inserted prongs acting upon the drive portions and the forces of the resilient members. In some embodiments, the slider frame 5a includes a support block 51 that protrudes from the bottom panel 501, and the resilient members include a first resilient member 9 compressed between the support block 51 and the first drive portion 63 and a second resilient member 10 compressed between the sidewall 502 and the second drive portion 72. This way, the transitions of the first slider block 6 and second slider block 7 between the different positions are responsive to the pressing force acting on the respective drive portions by the respective inserted objects and the spring force exerted by the respective resilient members. Therefore, when only one object is inserted into only one of the socket holes, the movement of one of the first slider block 6 or second slider block 7 (but not both) will not expose the openings of the slider frame; but when two objects are simultaneously inserted into both socket holes, the first slider block 6 and second slider block 7 move simultaneously to expose the openings.

Preferably, in their initial states (when no objects are inserted), the first resilient member 9 and second resilient member 10 respectively cause the first slider block 6 and second slider block 7 to respectively cover the openings, i.e., the first state. This way, the safety shield assembly can effectively prevent foreign objects being inserted, or one prong being mistakenly inserted. Further, in the initial state, the safety shield assembly can isolate the components within the receptacle from the external environment, and protect from the environmental factors such as dust, moisture, etc.

In some embodiments, the first drive portion 63 of the first slider block 6 includes a first inclined surface 632, as shown in FIG. 5A, and the second drive portion 72 of the second slider block 7 includes a second inclined surface 722, as shown in FIG. 6A. The first inclined surface 632 and second inclined surface 722 are inclined in the same direction, as shown in FIG. 3B. One inserted object pushing against the first inclined surface 632 or second inclined surface 722 can cause the first slider block 6 or second slider block 7 to move individually; only when two objects simultaneously push against the first inclined surface 632 and second inclined surface 722 can the first slider block 6 and second slider block 7 move simultaneously in the same direction. The first resilient member 9 and second resilient member 10 may be springs, and the first slider block 6 and second slider block 7 respectively have position limiting members for restraining the first resilient member 9 and second resilient member 10, such as the first pin 631 on the first drive portion 63, and the second pin 721 on the second drive portion 72, as shown in FIG. 3B. The support block 51 of the slider frame 5a has a first slot 511 corresponding to the first pin 631, so that the first resilient member 9 may be restrained by having its first end 901 disposed around the first pin 631 and its second end 902 disposed in the first slot 511. Similarly, the sidewall of the slider frame 5a has a second slot 520 corresponding to the second pin 721, so that the second resilient member 10 may be restrained by having its first end 101 disposed around the second pin 721 and its second end 102 disposed in the second slot 520. This design simplifies the structure and reduces the space taken by the safety shield assembly in the receptacle. It should be understood that other position limiting structures may be employed; for example, the pins may be replaced by slots and the slots may be replaced by pins.

When two objects are simultaneously inserted into the two socket holes and push against the first inclined surface 632 (first drive portion 63) and second inclined surface 722 (second drive portion 72), the first slider block 6 and second slider block 7 move simultaneously and compress the first resilient member 9 and second resilient member 10 respectively, so that they are in the second positions which exposes the first opening 503 and second opening. When only one object is inserted into only one socket hole and push against only one of the first inclined surface 632 and second inclined surface 722, only one of the first slider block 6 and second slider block 7 moves to compress the corresponding resilient member, so that the first blocking portion 62 and second blocking portion 73 can still respectively cover the second opening or the first opening, so as to provide the protection function.

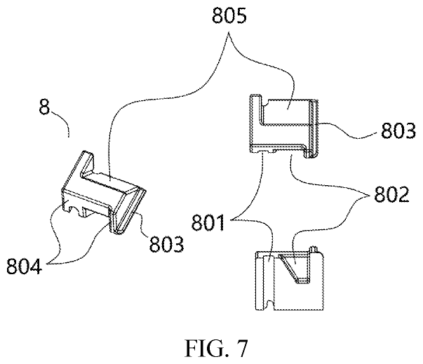

For a T-shaped second opening, the third slider block 8 and the second slider block 7 cooperate to achieve covering or exposing of the second opening. More specifically, the third slider block 8 includes a third blocking portion that corresponds in position to the second (transverse) portion 505 of the T-shaped second opening. As shown in FIGS. 4A and 7, the slider frame 5a has a blocking arm 53 extending perpendicularly from the sidewall 502. The blocking arm 53 is adjacent to and extends approximately parallel to the transverse portion 505 of the second opening, so as to define the movement space of the third slider block 8. In other words, the blocking arm 53 and the sidewall portion parallel to the blocking arm 53 form a sliding chamber or region 54 (FIG. 4A) in which the third slider block 8 moves. The inner surface of the sidewall portion parallel to the blocking arm 53 has an avoidance slot 507, which serves to increase the space of the sliding chamber 54 so that when the third slider block 8 is in the second position, the transverse portion 505 of the second opening can be completely open. When the second slider block 7 is in the second position, the second support arm 71 blocks the third slider block 8. As shown in FIG. 6A, the second support arm 71 has a blocking surface 76 on the side facing the third slider block 8, which abuts the corresponding contact surface 804 on the third slider block 8, so as to block the third slider block 8 from moving to the second position.

In some embodiments, as shown in FIGS. 3B and 6A-7, the third slider block 8 has a third drive portion, which is integrated with the third blocking portion; more specifically, the third drive portion includes a third inclined surface 805. Further, the second support arm 71 is provided with a cam block 74 at the end; the cam block 74 has an inclined lead-in surface and is configured to be inserted into a corresponding drive groove 802 of the third slider block 8. The drive groove 802 has a guide surface that corresponds to the lead-in surface of the cam block 74, so that the cam block 74 can transmit the spring force of the second resilient member 10 to the third slider block 8 via a movement along the drive groove 802. The size of the drive groove 802 is preferably larger than the size of the cam block 74. During the movement of the second slider block 7 and third slider block 8 from the first positions to the second positions, the movement of the cam block 74 along the drive groove 802 causes the blocking surface 76 to no longer contact the contact surface 804, allowing the third slider block 8 to move to the second position. During the movement of the second slider block 7 and third slider block 8 from the second positions to the first positions, the movement of the cam block 74 along the drive groove 802 causes the spring force exerted by the second resilient member 10 on the second slider block 7 to be transmitted to the third slider block 8, thereby driving the third slider block 8 toward the first position, and due to the contact of the blocking surface 76 and the contact surface 804, the third slider block 8 is prevented from moving toward the second position. In some embodiments, the second support arm 71 has an avoidance slot 75 adjacent the cam block 74, which is configured to allow the third slider block 8 to move to the second position, where at the second position, the transverse portion 505 of the second opening is completely open.

Preferably, the slider frame 5a includes a third guiding member. As shown in FIG. 4A, the third guiding member 541 is perpendicular to the first guiding member 506a and second guiding member 506b. It may be a guiding groove or guiding rail, such as a guiding rail shown in the drawing. The third slider block 8 has a third sliding portion 801 that cooperates with the third guiding member 541, such as a sliding block, a sliding rail, or a sliding groove. A sliding groove is shown in the drawing.

Preferably, the slider frame 5a further includes meshing teeth corresponding to the respective slider blocks, such that at the first positions, the slider blocks completely cover the corresponding openings of the slider frame 5a. More specifically, as shown in FIG. 4A, the support block 51 of the bottom panel 501 has a first meshing tooth 512 that matches the first blocking portion 62 of the first slider block 6 and the second drive portion 72 of the second slider block 7. The first meshing tooth 512 abuts or meshes with the first blocking portion 62 and the second drive portion 72 at the first positions. The side surface of the blocking arm 53 facing the longitudinal portion 504 of the second opening has a second meshing tooth 531, and the third slider block 8 has a fourth meshing tooth 803 which faces the first slider block 6 and is aligned with the second meshing tooth 531; both the second meshing tooth 531 and the fourth meshing tooth 803 abut or mesh with the second blocking portion 73 of the second slider block 7 and the first drive portion 63 of the first slider block 6 at the first positions. Moreover, the side surface of the blocking arm 53 facing the transverse portion 505 of the second opening has a third meshing tooth 532, which abuts or meshes with the third slider block 8 at the first position. Optionally, one or more of the first slider block 6, second slider block 7 and third slider block 8 may have a meshing portion that matches the above-described meshing teeth.

In some embodiments, the slider frame 5a further includes an indicator opening for an indicator device to pass through. For example, as shown in FIGS. 2 and 4A, the indicator opening 508 is located near the sidewall 502, such as near at least one corner of the sidewall. An indicator device, such as a light rod 13 connected to an indicator light source, may pass through the indicator opening 508 and extend upwards to the upper cover 1, allowing the user to observe the indicator light from the exterior of the receptacle.

FIG. 4B illustrates another slider frame 5b according to another embodiment of the present invention. One difference between slider frame 5b and the slider frame 5a of FIG. 4A is that slider frame 5b does not include structures related to the third slider block, such as the guiding member for guiding the third slider block, etc. This slider frame 5b is suitable for the safety shield assembly 4 corresponding to the I-shaped first socket hole 11 and second socket hole 14 shown in FIG. 2. Other structures of the slider frame 5b are similar to those of slider frame 5a and further descriptions are omitted here.

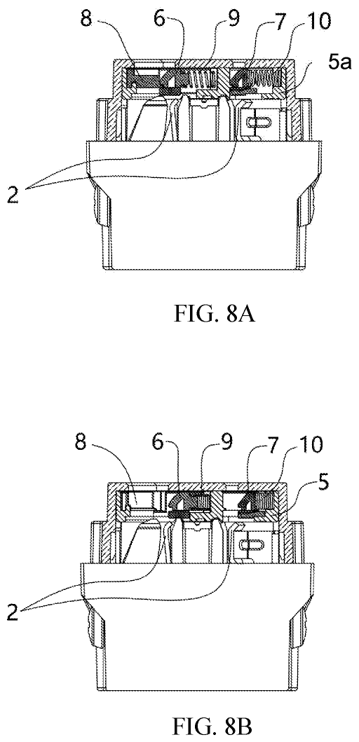

The operation principles of the safety shield assembly according to embodiments of the present invention are described with reference to FIGS. 8A-10B.

First, when no object is inserted into any socket hole, as shown in FIG. 8A, the safety shield assembly is in a closed state as the first slider block 6, second slider block 7 and third slider block 8 are all in their first positions under the force of the first resilient member 9 and second resilient member 10. In this state, the first opening and second opening are both covered. When two objects meeting the plug prong requirements are inserted into the two socket holes, FIG. 8B shows the state of the safety shield assembly in normal use. Now, the first slider block 6, second slider block 7 and third slider block 8 are all in their second positions, and the safety shield assembly is in the open state where the first opening and second openings are both exposed, so that the inserted prongs contacts the blade-receiving conductor plates 2. It should be understood that when the plug prongs are withdrawn, due to the spring force, the three slider blocks automatically return to the initial positions (first positions), and the safety shield assembly continues to perform their protection function.

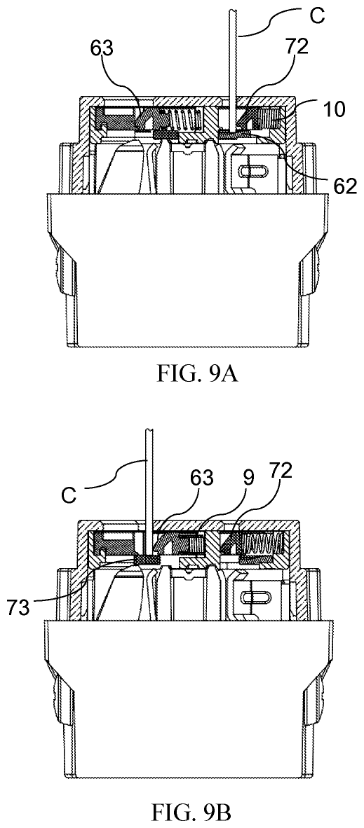

When a foreign object C is inserted into only one but not both of the socket holes, for examiner into the socket hole on the right as shown in FIG. 9A, the object C contacts the second drive portion 72 of the second slider block 7 and moves downwardly, which exerts a compression force on the second resilient member 10. Because the first drive portion 63 of the first slider block 6 does not experience a force, the first blocking portion 62 still covers the first opening of the slider frame, so that the object C cannot pass through the safety shield assembly.

Similarly, when an object C is inserted into only the socket hole on the left as shown in FIG. 9B, more specifically, into the longitudinal portion of the second socket hole, the object C contacts the first drive portion 63 of the first slider block 6 and moves downwardly, which exerts a compression force on the first resilient member 9. Because the second drive portion 72 of the second slider block 7 does not experience a force, the second blocking portion 73 still covers the second opening of the slider frame, so that the object C cannot pass through the safety shield assembly.

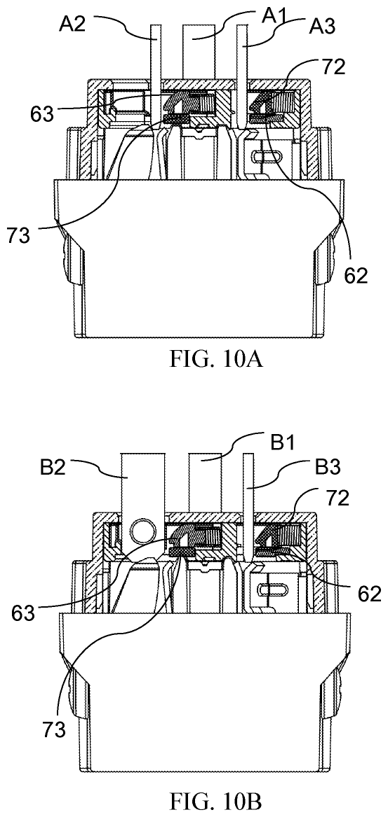

FIG. 10A shows an electrical plug having prongs A1, A2 and A3 being plugged into the receptacle. When the two parallel longitudinal prongs A2, A3 are inserted into the two socket holes and contact the first drive portion 63 and second drive portion 72 of the two slider blocks simultaneously, the first slider block 6 and second slider block 7 respectively receive the force from the prongs and move along the slider frame against the spring force of the respective first and second springs, so that the first blocking portion 62 and second blocking portion 73 expose the first opening and the first portion of the second opening (the longitudinal portion that corresponds to the longitudinal portion of the second socket hole). As a result, the two prongs pass through the safety shield assembly and contact the blade-receiving conductor plates inside the receptacle to output electrical power normally.

As shown in FIG. 10B, when an electrical plug having prongs B1, B2 and B3 is plugged into the receptacle, the longitudinal prong B3 and the transverse prong B2 are inserted into the two socket holes and contact the first drive portion 63 and second drive portion 72 of the two slider blocks simultaneously. The first slider block 6 and second slider block 7 respectively receive the force from the prongs and move along the slider frame against the spring force of the respective first and second springs, so that the first blocking portion 62 and second blocking portion 73 expose the first opening and the first (longitudinal) portion of the second opening. Meanwhile, the third slider block moves along the slider frame to expose the second (transverse) portion of the second opening. Note that in this process, the transverse prong B2 pushes against the third inclined surface 805 of the third slider block 8 to urge it toward the second position, but the third slider block 8 can only move after the blocking surface 76 of the second slider block 7 has moved out of the way. As a result, the two prongs pass through the safety shield assembly and contact the blade-receiving conductor plates inside the receptacle to output electrical power normally.

The safety shield assembly according to embodiments of the present invention has a simple and compact structure, is safe and reliable, and can be used in different types of receptacle structure without significant change, making it versatile. Further, the safety shield assembly is made of a small number of components, and the components can restrain the positions of each other, allowing for automatic manufacturing and assembly.

It should be understood that the embodiments shown in the drawings only illustrate the preferred shapes, sizes and spatial arrangements of the various components of the safety shield assembly and receptacle. These illustrations do not limit the scope of the invention; other shapes, sizes and spatial arrangements may be used without departing from the spirit of the invention. Further, the slider frame, first slider block and second slider block in the above embodiments are each integrally formed as one piece, making them easy to manufacture and assemble. Each of these parts may also be formed as multiple pieces or multiple groups, depending on the number of socket holes of the receptacle,

It will be apparent to those skilled in the art that various modification and variations can be made in the embodiments of the present invention without departing from the spirit or scope of the invention. Thus, it is intended that the present invention cover modifications and variations that come within the scope of the appended claims and their equivalents.

1. A safety shield assembly for a power receptacle, the safety shield assembly comprising:
a slider frame, having a bottom panel and a sidewall that extends along a periphery of and perpendicularly from the bottom panel, the bottom panel defining a first opening and a second opening having shapes corresponding to shapes of socket holes of the power receptacle;
a first slider block, disposed in the slider frame, including a first blocking portion corresponding in position to the first opening; and
a second slider block, disposed in the slider frame, and including a second blocking portion corresponding in position to the second opening;
wherein the bottom panel further includes one or more guiding members, wherein the first slider block and second slider block are configured to move within a space defined by the sidewall, as guided by the guiding members and under spring force of one or more resilient members, between first positions where the first opening and the second opening are covered, and second positions where the first opening and the second opening are exposed.

2. The safety shield assembly of claim 1, wherein the first slider block includes a first support arm, wherein the first blocking portion extends perpendicularly from the first support arm, wherein the first slider block further includes a first drive portion which extends perpendicularly from the first support arm and is parallel to and spaced apart from the first blocking portion;
wherein the second slider block includes a second support arm, wherein the second blocking portion extends perpendicularly from the second support arm, wherein the second slider block further includes a second drive portion which extends perpendicularly from the second support arm and is parallel to and spaced apart from the second blocking portion;
wherein the first slider block and second slider block are disposed in a nested arrangement, where the first blocking portion is located below the second drive portion, and the second blocking portion is located below the first drive portion, wherein the first slider block and second slider block are configured to move in a same direction to the second positions when the first drive portion and the second drive portion are simultaneously driven.

3. The safety shield assembly of claim 2, wherein the one or more guiding members includes a first guiding member corresponding to the first slider block and a second guiding member corresponding to the second slider block, wherein the first support arm has a first sliding portion that cooperates with the first guiding member, and the second support arm has a second sliding portion that cooperates with the second guiding member.

4. The safety shield assembly of claim 3, wherein the first guiding member and the second guiding member are disposed in parallel, each being a guiding groove or a guiding rail, and wherein each of the first sliding portion and second sliding portion is a sliding block, a sliding rail, or a sliding groove.

5. The safety shield assembly of claim 2, wherein the first drive portion includes a first inclined surface and the second drive portion includes a second inclined surface, wherein the first slider block or the second slider block are configured to move individually when an inserted object pushes against the first inclined surface or the second inclined surface, and wherein the first slider block and the second slider block are configured to move simultaneously in a same direction when two inserted objects simultaneously push against the first inclined surface and second inclined surface.

6. The safety shield assembly of claim 3, wherein the second opening includes a first portion and a second portion perpendicular to each other, wherein the second blocking portion of the second slider block corresponds to the first portion of the second opening;
wherein the safety shield assembly further comprises:
a third slider block disposed in the slider frame, including a third blocking portion corresponding to the second portion of the second opening;
wherein the one or more guiding members further includes a third guiding member, and the third slider block includes a third sliding portion cooperating with the third guiding member, wherein the third slider block is configured to move between a first position where it covers the second portion of the second opening and a second position where it exposes the second portion of the second opening.

7. The safety shield assembly of claim 6, wherein the third guiding member is perpendicular to the first guiding member or the second guiding member, and is a guiding groove or a guiding rail, and the third sliding portion is a sliding block, a sliding rail, or a sliding groove.

8. The safety shield assembly of claim 6, wherein the slider frame further includes a blocking arm extending perpendicularly from the sidewall, wherein the blocking arm is adjacent to and extends approximately parallel to the second portion of the second opening, and defines a movement space of the third slider block, and wherein an inner surface of a portion of the sidewall parallel to the blocking arm has an avoidance slot.

9. The safety shield assembly of claim 8, wherein when the second slider block is in its first position, the second support arm blocks the third slider block and prevents the third slider block from moving to its second position.

10. The safety shield assembly of claim 6, wherein the second support arm includes a cam block at its end, wherein the cam block has an inclined lead-in surface and is configured to be inserted into a corresponding drive groove of the third slider block, wherein the drive groove has a guide surface that corresponds to the lead-in surface of the cam block, and wherein the cam block transmits the spring force of the resilient members to the third slider block via a movement along the drive groove.

11. The safety shield assembly of claim 10, wherein the second support arm has an avoidance slot adjacent the cam block, which is configured to allow the third slider block to move to the second position.

12. The safety shield assembly of claim 1, wherein the slider frame further includes an indicator opening configured to accommodate an indicator device to pass through, wherein the indicator opening is located near the sidewall.

13. The safety shield assembly of claim 2, wherein the slider frame further includes a support block that protrudes from the bottom panel, and wherein the resilient members include a first resilient member compressed between the support block and the first drive portion and a second resilient member compressed between the sidewall and the second drive portion.

14. A power receptacle comprising:
a shell including a top cover with socket holes;
blade-receiving conductor plates disposed within the shell and spatially correspond to the socket holes; and
the safety shield assembly of claim 1, disposed between the top cover and the conductor plates.
